(19) United States
(12) Patent Application Publication
(10) Pub. No.: US 2017/0009924 A1
(43) Pub. Date: Jan. 12, 2017

(54) Retrofitted Pipe Conduit Addition Method And Assembly

(71) Applicants: Justin Madsen, Clinton, WA (US); Mike Madsen, Clinton, WA (US)

(72) Inventors: Justin Madsen, Clinton, WA (US); Mike Madsen, Clinton, WA (US)

(21) Appl. No.: 14/795,979

(22) Filed: Jul. 10, 2015

(51) Int. Cl. F16L 41/02; F16L 37/02; F16L 41/04

(52) U.S. Cl. CPC F16L 41/021; F16L 41/04; F16L 37/02

(57) ABSTRACT

A retrofitted pipe conduit addition method and assembly includes a pipe having a cylindrical shape and which has an outer diameter. A coupler is positioned on the pipe. A cylinder is integrally coupled to and extends away from the coupler. The coupler has an aperture extending therethrough. The cylinder bounds the aperture. The pipe has an opening extending therethrough and the cylinder is aligned with the opening. The cylinder may then be fluidly coupled to a drainage conduit.

### BACKGROUND OF THE DISCLOSURE

### Field of the Disclosure

The disclosure relates to pipe fitting devices and more particularly pertains to a new pipe fitting device for facilitating the attachment or moving of downspouts.

### SUMMARY OF THE DISCLOSURE

An embodiment of the disclosure meets the needs presented above by generally comprising a pipe having a cylindrical shape and which has an outer diameter. A coupler is positioned on the pipe. A cylinder is integrally coupled to and extends away from the coupler. The coupler has an aperture extending therethrough. The cylinder bounds the aperture. The pipe has an opening extending therethrough and the cylinder is aligned with the opening. The cylinder may then be fluidly coupled to a drainage conduit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective top view of a retrofitted pipe conduit addition method and assembly according to an embodiment of the disclosure.

FIG. 2 is a perspective bottom view of an embodiment of the disclosure.

FIG. 3 is a cross-sectional view of an embodiment of the disclosure taken along line 3-3 of FIG. 1.

FIG. 4 is a top view of an embodiment of the disclosure.

FIG. 5 is a side front in-use view of an embodiment of the disclosure.

### DESCRIPTION OF THE PREFERRED EMBODIMENT

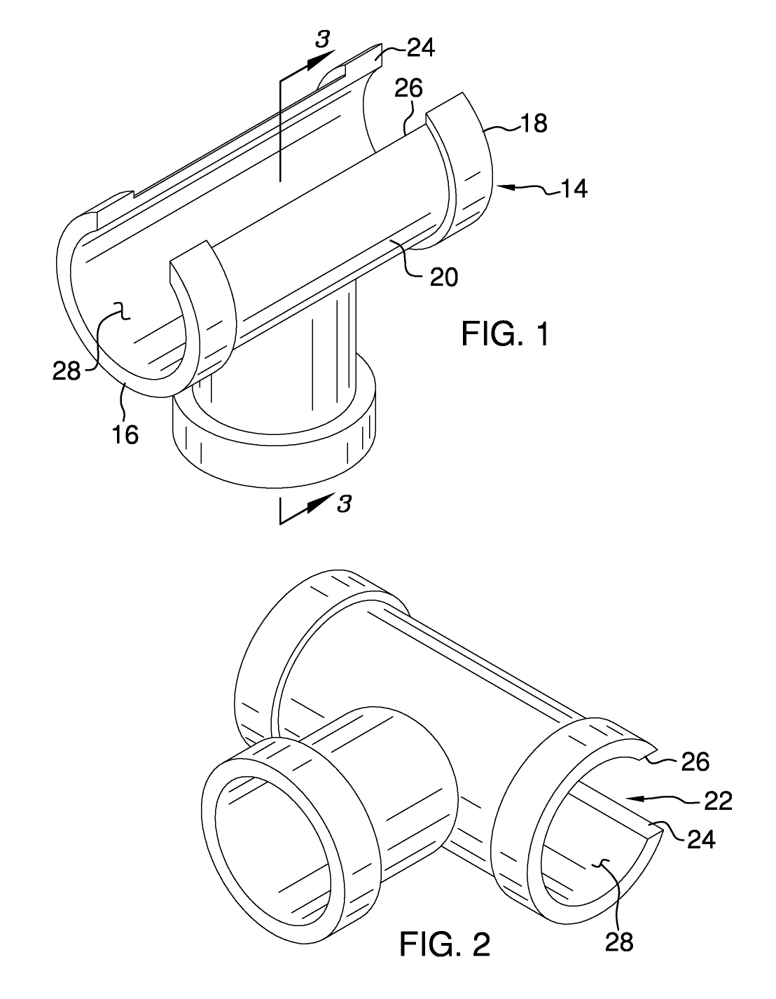

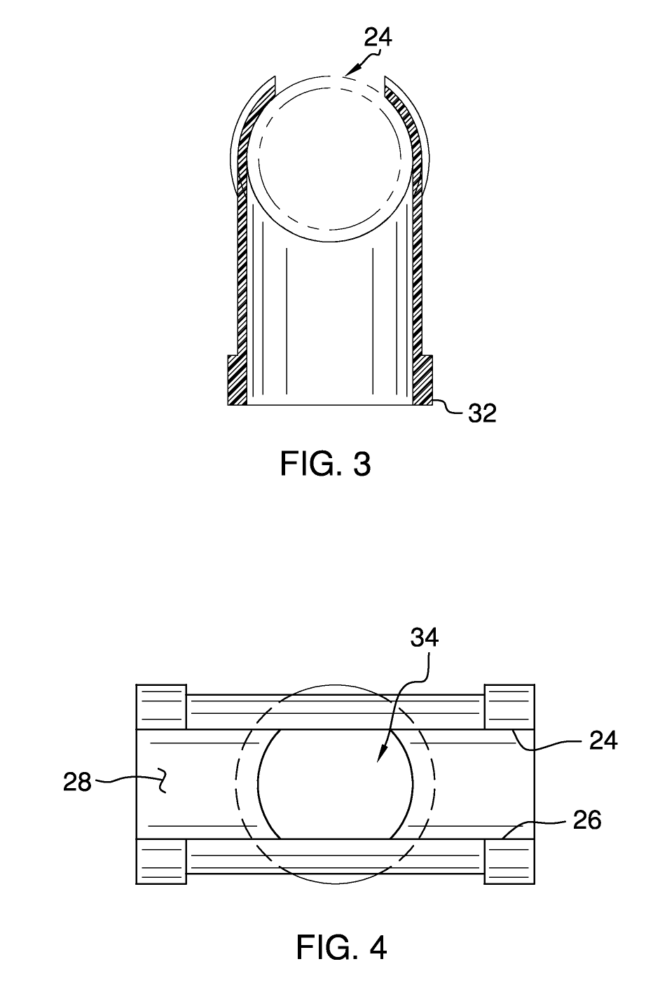

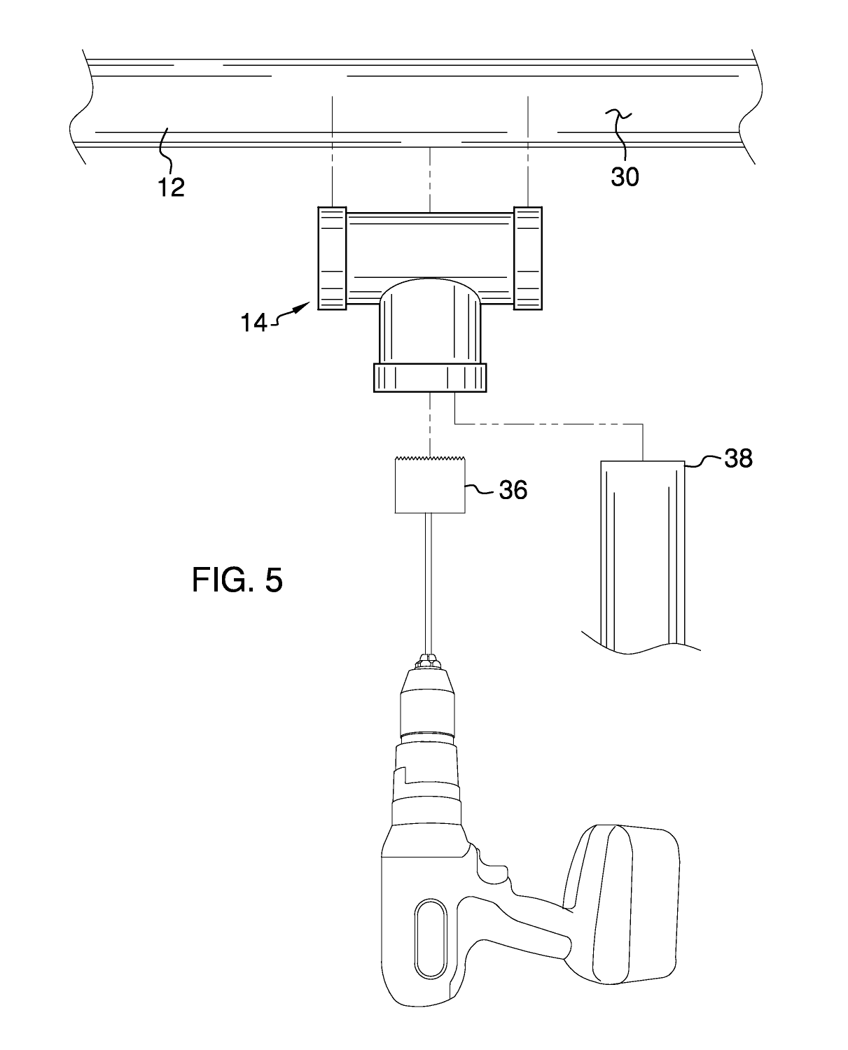

With reference now to the drawings, and in particular to FIGS. 1 through 5 thereof, a new pipe fitting device embodying the principles and concepts of an embodiment of the disclosure and generally designated by the reference numeral 10 will be described.

As best illustrated in FIGS. 1 through 5, the retrofitted pipe conduit addition method and assembly 10 generally comprises providing a pipe 12 having a cylindrical shape and which has an outer diameter. The pipe 12 may include any conventional pipe particularly suited for carrying water or other liquid and may include downspout pipe for carrying water away from or down a building.

A coupler 14 is snapped onto the pipe 12. The coupler 14 is elongated and has a first end 16, a second end 18 and a perimeter wall 20 extending between the first 16 and second 18 ends. The perimeter wall 20 may have length approximately between 3.0 inches and 8.0 inches. The first 16 and second 18 ends are open and the perimeter wall 20 has elongated break 22 therein extending through each of the first 16 and second 18 ends. A first edge 24 and a second edge 26 is defined on opposite sides of the break 22. The perimeter wall 20 has a semi-circular cross-section taken perpendicular to a longitudinal axis of the perimeter wall 20 extending through the first 16 and second 18 ends. The coupler 14 has an inner diameter that is equal to or less than the outer diameter of the pipe 12 and a distance between the first 24 and second 26 edges is less than the outer diameter. A distance extending along an inner surface 28 from the first edge 24 to the second edge 26 is greater than ½ of a circumference of an outer surface 30 of the pipe 12.

The perimeter wall 20 is comprised of a resiliently bendable material such as plastic. The coupler 14 is snapped onto the pipe 12 by moving the pipe 12 through the break 22 such that the perimeter wall 20 abuts and frictionally engages the pipe 12.

Because the materials of the perimeter wall 20 cause the first 24 and second 26 edges to want to remain in their original positions relative to each other, the first 24 and second 26 edges are biased towards each other as the pipe 12 is moved through the break 22 such the first 24 and second 26 edges snap towards each other when they pass opposite sides of a diameter of the pipe 12. Because the perimeter wall 20 has an inner size greater than ½ the outer size of the pipe 12, the pipe 12 is essentially pulled into the perimeter wall 20.

A cylinder 32 is integrally coupled to and extends away from the coupler 14. The cylinder 32 bounds an aperture 34 in the coupler 14. A drill bit 36 is extended through the cylinder 32 to drill a hole through the pipe 12 such that the opening is aligned with the aperture 34. A drain conduit 36 is then connected with the cylinder 32 such that the drain conduit 38 is fluidly coupled to the pipe 12. In this manner, the drain conduit 38 may be added where needed without movement of the pipe 12. Thus, a downspout needs to be moved to a more suitable location, this may be done by adding the drain conduit 38 to act as the downspout as opposed to replacing or moving the pipe 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A conduit retrofitting system including:
a pipe having a cylindrical shape and having an outer diameter;
a coupler being positioned on said pipe;
a cylinder being integrally coupled to and extending away from said coupler, said coupler having an aperture extending therethrough, said cylinder bounding said aperture; and
said pipe having an opening extending therethrough, said cylinder being aligned with said opening, wherein said cylinder is configured to be fluidly coupled to a drainage conduit.

2. The conduit retrofitting system according to claim 1, wherein said coupler is elongated and has a first end, a second end and a perimeter wall extending between said first and second ends, said first and second ends being open, said perimeter wall having elongated break therein extending through each of said first and second ends, a first edge and a second edge being defined on opposite sides of said break, said perimeter wall having a semi-circular cross-section taken perpendicular to a longitudinal axis of said perimeter wall extending through said first and second ends, said coupler having an inner diameter being equal to or less than said outer diameter, a distance between said first and second edges being less than said outer diameter.

3. The conduit retrofitting system according to claim 2, wherein a distance between said first and second ends is between 3.0 inches and 8.0 inches.

4. The conduit retrofitting system according to claim 2, wherein said perimeter wall is comprised of a resiliently bendable material.

5. A method of adding a conduit to a drainage pipe, said method including the steps of:
providing a pipe having a cylindrical shape and having an outer diameter;
snapping a coupler onto said pipe, said coupler being elongated and having a first end, a second end and a perimeter wall extending between said first and second ends, said first and second ends being open, said perimeter wall having elongated break therein extending through each of said first and second ends, a first edge and a second edge being defined on opposite sides of said break, said perimeter wall having a semi-circular cross-section taken perpendicular to a longitudinal axis of said perimeter wall extending through said first and second ends, said coupler having an inner diameter being equal to or less than said outer diameter, a distance between said first and second edges being less than said outer diameter, said perimeter wall being comprised of a resiliently bendable material, wherein said step of snapping said coupler onto said pipe includes moving said pipe through said break such that said perimeter wall abuts and frictionally engages said pipe, a cylinder being integrally coupled to and extending away from said coupler, said cylinder bounding an aperture in said coupler;
extending a drill bit through said cylinder and drilling a hole through said perimeter wall such that said opening is aligned with said aperture; and
connecting a drain conduit with said cylinder such that said drain conduit is fluidly coupled to said pipe.
